(19) United States
(12) Patent Application Publication
(10) Pub. No.: US 2020/0151197 A1
(43) Pub. Date: May 14, 2020

(54) SYSTEMS AND METHODS FOR JOINING DATA SETS

(71) Applicant: BEIJING DIDI INFINITY TECHNOLOGY AND DEVELOPMENT CO., LTD., Beijing (CN)

(72) Inventors: Minghao GUO, Beijing (CN); Xiang WEN, Beijing (CN); Yi CHAI, Beijing (CN)

(73) Assignee: BEIJING DIDI INFINITY TECHNOLOGY AND DEVELOPMENT CO., LTD., Beijing (CN)

(21) Appl. No.: 16/743,654

(22) Filed: Jan. 15, 2020

Related U.S. Application Data
(63) Continuation of application No. PCT/CN2017/119894, filed on Dec. 29, 2017.
Application No. PCT/CN2017/119894 is a continuation-in-part of application No. PCT/CN2017/119699, filed on Dec. 29, 2017.

(51) Int. Cl. G06F 16/27; G06F 16/22

(52) U.S. Cl. CPC G06F 16/278; G06F 16/2228

(57) ABSTRACT

A system to optimize Spatial Big Data partitions may perform a method including obtaining a first data set that is a Spatial Big Data set associated with spatial information within a target region. The method may also include dividing the first data set into a plurality of first preliminary partitions based on the spatial information. The method may also include determining a first spatial index for the first data set based on the plurality of first preliminary partitions. The method may also include generating a plurality of first modified partitions by obtaining a plurality of first boundary data sets associated with the plurality of first preliminary partitions based on the first spatial index and conducting a first shuffling operation to the plurality of first boundary data sets.

### CROSS-REFERENCE TO RELATED APPLICATIONS

This application is a continuation of International Application No. PCT/CN2017/119894, filed on Dec. 29, 2017, which claims priority to International Application No. PCT/CN2017/119699 filed on Dec. 29, 2017, the contents of which are incorporated herein by reference.

### TECHNICAL FIELD

The present disclosure generally relates to management of spatial big data, and more specifically, relates to systems and methods for joining data sets.

### BACKGROUND

In the Internet era, an online on-demand service platform may receive, from its users or other entities, a spatial big data set including real time or historical locations of the users. A joining operation may be performed to combine the spatial big data set with another dada set. For example, a joining operation may be performed to compare a spatial big data set with a data set including a road network map to determine a new road not included in the road network map. However, because the amount of data in a spatial big data set is extremely large, it is difficult to process the spatial big data set efficiently. Therefore, it is desirable to provide systems and methods for joining data sets to process a spatial big data set efficiently.

### SUMMARY

According to a first aspect of the present disclosure, a data processing electronic system to optimize Spatial Big Data partitions may include at least one storage device and at least one processor configured to communicate with the at least one storage device. The at least one storage device may include a set of instructions. When executing the set of instructions, the at least one processor may be directed to perform one or more of the following operations. The at least one processor may obtain a first data set. The first data set may be a Spatial Big Data set associated with spatial information within a target region. The at least one processor may divide the first data set into a plurality of first preliminary partitions based on the spatial information. The at least one processor may determine a first spatial index for the first data set based on the plurality of first preliminary partitions. The at least one processor may generate a plurality of first modified partitions by obtaining a plurality of first boundary data sets associated with the plurality of first preliminary partitions based on the first spatial index and conducting a first shuffling operation to the plurality of first boundary data sets. The plurality of first boundary data sets may include data associated with one or more first regions surrounding the plurality of first preliminary partitions.

In some embodiments, the at least one processor may determine a spatial index range for each of the plurality of first preliminary partitions based on the first spatial index. The at least one processor may determine the plurality of first boundary data sets associated with the plurality of first preliminary partitions based on the spatial index ranges of the plurality of first preliminary partitions.

In some embodiments, the at least one processor may conduct distribute computation to the plurality of first preliminary partitions to generate the plurality of first modified partitions according to a distributed computing method.

In some embodiments, the at least one processor may obtain a second data set within the target region. The at least one processor may divide the second data set into a plurality of second preliminary partitions. The at least one processor may determine a second spatial index for the second data set based on the plurality of second preliminary partitions. The at least one processor may conduct distributed computation to the plurality of second preliminary partitions to generate a plurality of second modified partitions according to the distributed computing method and the second spatial index.

In some embodiments, to generate the plurality of second modified partitions, the at least one processor may obtain a plurality of second boundary data sets associated with the plurality of second preliminary partitions based on the second spatial index. The plurality of second boundary data sets may include data associated with one or more second regions surrounding the plurality of second preliminary partitions. The at least one processor may conduct a second shuffling operation to the plurality of second boundary data sets to generate the plurality of second modified partitions.

In some embodiments, the at least one processor may join at least one of the plurality of first modified partitions in the first data set and at least one of the plurality of second modified partitions in the second data set.

In some embodiments, the first data set may include tracing points of a plurality of user terminals communicated with the electronic system, and the second data set includes road network information of the target region.

In some embodiments, for each of the plurality of second modified partitions, a location of the second modified partition, an area of the second modified partition, and a shape of the second modified partition may be same as one of the plurality of first modified partitions.

In some embodiments, the first spatial index or the second spatial index may be associated with at least one of a Hilbert curve or a Z-curve.

In some embodiments, the distributed computing method may include at least one of Spark framework, Hadoop, Phoenix, Disco, or Mars.

According to another aspect of the present disclosure, a method to optimize Spatial Big Data partitions may include one or more of the following operations. At least one processor may obtain a first data set. The first data set may be a Spatial Big Data set associated with spatial information within a target region. The at least one processor may divide the first data set into a plurality of first preliminary partitions based on the spatial information. The at least one processor may determine a first spatial index for the first data set based on the plurality of first preliminary partitions. The at least one processor may generate a plurality of first modified partitions by obtaining a plurality of first boundary data sets associated with the plurality of first preliminary partitions based on the first spatial index and conducting a first shuffling operation to the plurality of first boundary data sets. The plurality of first boundary data sets may include data associated with one or more first regions surrounding the plurality of first preliminary partitions.

According to yet another aspect of the present disclosure, a non-transitory computer readable medium may comprise at least one set of instructions. The at least one set of instructions may be executed by at least one processor of a computer server. The at least one processor may obtain a first data set. The first data set may be a Spatial Big Data set associated with spatial information within a target region. The at least one processor may divide the first data set into a plurality of first preliminary partitions based on the spatial information. The at least one processor may determine a first spatial index for the first data set based on the plurality of first preliminary partitions. The at least one processor may generate a plurality of first modified partitions by obtaining a plurality of first boundary data sets associated with the plurality of first preliminary partitions based on the first spatial index and conducting a first shuffling operation to the plurality of first boundary data sets. The plurality of first boundary data sets may include data associated with one or more first regions surrounding the plurality of first preliminary partitions.

According to yet another aspect of the present disclosure, a system to optimize Spatial Big Data partitions may include an obtaining module configured to obtain a first data set. The first data set may be a Spatial Big Data set associated with spatial information within a target region. The system may also include a data set processing module configured to divide the first data set into a plurality of first preliminary partitions based on the spatial information and determine a first spatial index for the first data set based on the plurality of first preliminary partitions. The system may also include an extension module configured to generate a plurality of first modified partitions by obtaining a plurality of first boundary data sets associated with the plurality of first preliminary partitions based on the first spatial index and conducting a first shuffling operation to the plurality of first boundary data sets. The plurality of first boundary data sets may include data associated with one or more first regions surrounding the plurality of first preliminary partitions.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary on-demand service system according to some embodiments of the present disclosure;

FIG. 2 is a schematic diagram illustrating exemplary hardware and/or software components of a computing device on which the processing engine 112 may be implemented according to some embodiments of the present disclosure;

FIG. 3 is a schematic diagram illustrating exemplary hardware and/or software components of a mobile device on which the user terminal 140 may be implemented according to some embodiments of the present disclosure;

FIG. 4 is a schematic block diagram illustrating an exemplary processing engine according to some embodiments of the present disclosure;

FIG. 5A is a flowchart illustrating an exemplary process for generating a plurality of first modified partitions according to some embodiments of the present disclosure;

FIG. 5B is a flowchart illustrating an exemplary process for joining two data sets according to some embodiments of the present disclosure;

FIG. 6 is a flowchart illustrating an exemplary process for dividing a data set into a plurality of partitions according to some embodiments of the present disclosure;

FIG. 7 is a flowchart illustrating an exemplary process for generating a plurality of modified partitions according to some embodiments of the present disclosure;

FIG. 8 is a schematic diagram illustrating an exemplary boundary data set according to some embodiments of the present disclosure;

FIG. 9 is a schematic diagram illustrating an exemplary process for determining a plurality of modified partitions based on a plurality of preliminary partitions based on a distributed computing method according to some embodiments of the present disclosure;

FIG. 10 is a schematic diagram illustrating exemplary modified partitions and exemplary preliminary partitions according to some embodiments of the present disclosure;

FIG. 11 is a schematic diagram illustrating exemplary corresponding modified partitions according to some embodiments of the present disclosure; and

FIG. 12 is a schematic diagram illustrating an exemplary process for joining two data sets based on a distributed computing method according to some embodiments of the present disclosure.

### DETAIL DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure, and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding joining data sets, it should also be understood that this is only one exemplary embodiment. The system or method of the present disclosure may be applied to any application scenario which may produce spatial big data. For example, the system and method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, a bicycle, a tricycle, a motorcycle, or the like, or any combination thereof. The system and method of the present disclosure may be applied to taxi hailing, chauffeur services, delivery service, carpool, bus service, take-out service, driver hiring, vehicle hiring, bicycle sharing service, train service, subway service, shuttle services, location service, or the like, among others. As used here, big data refers to data of which the amount is large to the extent that requires indexing for efficient processing.

The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure relates to systems and methods for joining data sets. Systems and methods in the present disclosure may be configured to join road network data sets with spatial big data sets including enormous (from a few billions to thousands of billion-scale) tracing points of user terminals communicated with an online on-demand service platform. To this end, the systems and methods provide an indexing system to support effectively management and processing of the data sets. According to embodiments of the present disclosure, the systems and methods may divide the special big data set into partitions and individually index each of the partitions. The systems and methods then may modify each of the partitions by adding thereto boundary data sets of regions surrounding the partitions and shuffle the boundary data sets. The systems and methods may do the same to the road network data set. When the online on-demand service platform needs to join a few partitions of the two data sets, such as when a user of the platform wants to know whether there is new road not included in an existing road network map, the above indexing systems of the two data sets may facilitate searching and joining of data from the two data sets in the corresponding partitions, especially when the data scale of the two data sets are of billion-scale and larger and the searching and joining operation is required to be completed in microseconds or nanoseconds.

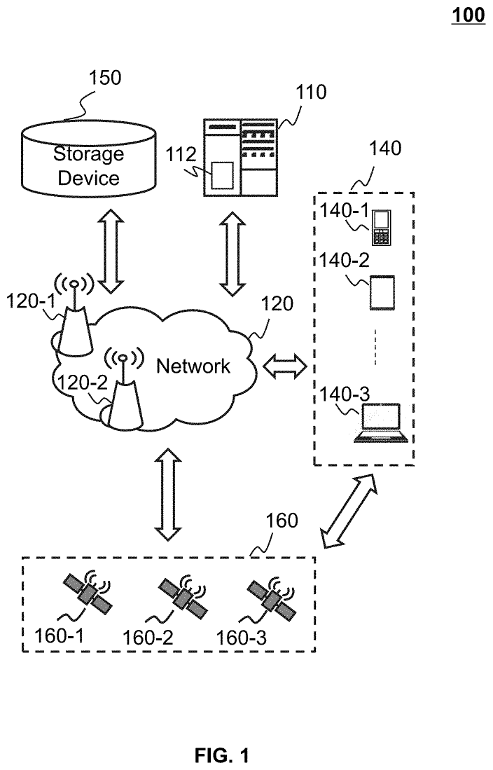

FIG. 1 is a schematic diagram of an exemplary on-demand service system according to some embodiments. The on-demand service system 100 may include a server 110, a network 120, a user terminal 140, a storage device 150, and a positioning system 160.

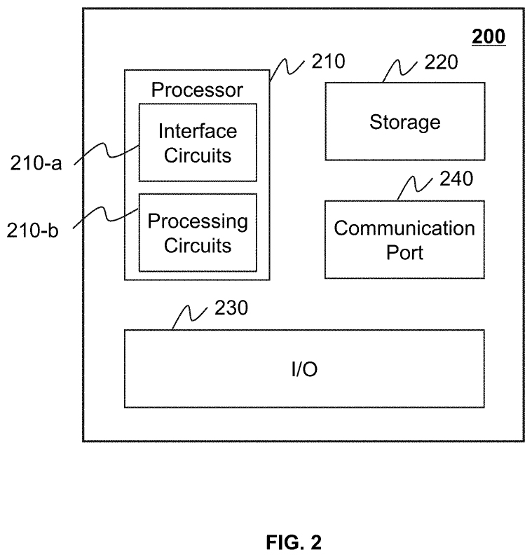

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the user terminal 140, and/or the storage device 150 via the network 120. As another example, the server 110 may be directly connected to the user terminal 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data to perform one or more functions described in the present disclosure. For example, the processing engine 112 may perform a shuffling operation on a partition in a spatial big data set. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the on-demand service system 100 (e.g., the server 110, the user terminal 140, the storage device 150, and the positioning system 160) may send information and/or data to other component(s) in the on-demand service system 100 via the network 120. For example, the processing engine 112 may obtain a plurality of data points from the storage device 150 and/or the user terminal 140 via the network 120. In some embodiments, the network 120 may be any type of wired or wireless network, or a combination thereof. Merely by way of example, the network 120 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, the user terminal 140 may include a mobile device 140-1, a tablet computer 140-2, a laptop computer 140-3, or the like, or any combination thereof. In some embodiments, the mobile device 140-1 may include a smart home device, a wearable device, a mobile equipment, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile equipment may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, the user terminal 140 may be a device with positioning technology for locating the position of the user terminal 140. In some embodiments, the user terminal 140 may send positioning information to the server 110.

The storage device 150 may store data and/or instructions. In some embodiments, the storage device 150 may store data obtained from the user terminal 140 and/or the processing engine 112. For example, the storage device 150 may store a plurality of data points obtained from the user terminal 140. As another example, the storage device 150 may store a shuffled partition in a spatial big data set determined by the processing engine 112. In some embodiments, the storage device 150 may store data and/or instructions that the server 110 may execute or use to perform exemplary methods described in the present disclosure. For example, the storage device 150 may store instructions that the processing engine 112 may execute or user to perform a shuffling operation on a partition in a spatial big data set. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components in the on-demand service system 100 (e.g., the server 110, the user terminal 140, etc.). One or more components in the on-demand service system 100 may access the data or instructions stored in the storage device 150 via the network 120. In some embodiments, the storage device 150 may be directly connected to or communicate with one or more components in the on-demand service system 100 (e.g., the server 110, the user terminal 140, etc.). In some embodiments, the storage device 150 may be part of the server 110.

The positioning system 160 may determine information associated with an object, for example, the user terminal 140. For example, the positioning system 160 may determine a location of the user terminal 140 in real time. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, an accumulative mileage number, or a current time. The location may be in the form of coordinates, such as, latitude coordinate and longitude coordinate, etc. The positioning system 160 may include one or more satellites, for example, a satellite 160-1, a satellite 160-2, and a satellite 160-3. The satellites 160-1 through 160-3 may determine the information mentioned above independently or jointly. The satellite positioning system 160 may send the information mentioned above to the network 120, or the user terminal 140 via wireless connections.

FIG. 2 is a schematic diagram illustrating exemplary hardware and/or software components of a computing device on which the processing engine 112 may be implemented according to some embodiments of the present disclosure. As illustrated in FIG. 2, the computing device 200 may include a processor 210, a storage 220, an input/output (I/O) 230, and a communication port 240.

The processor 210 (e.g., logic circuits) may execute computer instructions (e.g., program code) and perform functions of the processing engine 112 in accordance with techniques described herein. For example, the processor 210 may include interface circuits 210-a and processing circuits 210-b therein. The interface circuits may be configured to receive electronic signals from a bus (not shown in FIG. 2), wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus.

The computer instructions may include, for example, routines, programs, objects, components, data structures, procedures, modules, and functions, which perform particular functions described herein. For example, the processor 210 may process a plurality of data points obtained from the user terminal 140, the storage device 150, and/or any other component of the on-demand service system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the user terminal 140, the storage device 150, and/or any other component of the on-demand service system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drives, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 220 may store one or more programs and/or instructions to perform exemplary methods described in the present disclosure. For example, the storage 220 may store a program for the processing engine 112 for performing a shuffling operation on a partition in a spatial big data set.

The I/O 230 may input and/or output signals, data, information, etc. In some embodiments, the I/O 230 may enable a user interaction with the processing engine 112. In some embodiments, the I/O 230 may include an input device and an output device. Examples of the input device may include a keyboard, a mouse, a touch screen, a microphone, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network (e.g., the network 120) to facilitate data communications. The communication port 240 may establish connections between the processing engine 112 and the user terminal 140, the positioning system 160, or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc.

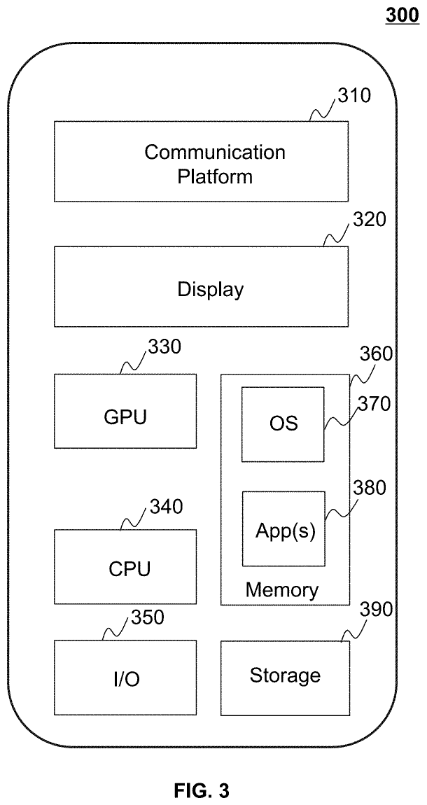

FIG. 3 is a schematic diagram illustrating exemplary hardware and/or software components of a mobile device on which the user terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the on-demand service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

One of ordinary skill in the art would understand that when an element of the on-demand service system 100 performs, the element may perform through electrical signals and/or electromagnetic signals. For example, when the processing engine 112 processes a task, such as making a determination, or identifying information, the processing engine 112 may operate logic circuits in its processor to process such task. When the processing engine 112 receives data (e.g., a plurality of data points) from the user terminal 140, a processor of the processing engine 112 may receive electrical signals including the data. The processor of the processing engine 112 may receive the electrical signals through an input port. If the user terminal 140 communicates with the processing engine 112 via a wired network, the input port may be physically connected to a cable. If the user terminal 140 communicates with the processing engine 112 via a wireless network, the input port of the processing engine 112 may be one or more antennas, which may convert the electrical signals to electromagnetic signals. Within an electronic device, such as the user terminal 140, and/or the server 110, when a processor thereof processes an instruction, sends out an instruction, and/or performs an action, the instruction and/or action is conducted via electrical signals. For example, when the processor retrieves or saves data from a storage medium (e.g., the storage device 150), it may send out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

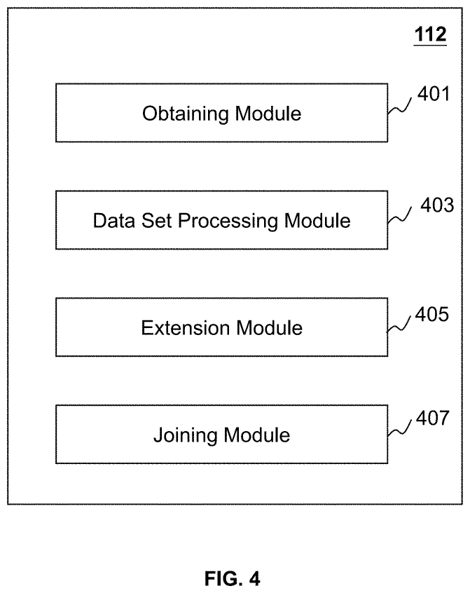

FIG. 4 is a schematic block diagram illustrating an exemplary processing engine according to some embodiments of the present disclosure. The processing engine 112 may include an obtaining module 401, a data set processing module 403, an extension module 405, and a joining module 407.

The obtaining module 401 may be configured to obtain a data set, such as a first data set including a plurality of data points associated with spatial information within a target region, and/or a second data set including road network information within a target region. In some embodiments, the obtaining module 401 may obtain the data set from the storage medium (e.g., the storage device 150, or the storage 220 in the computing device 200).

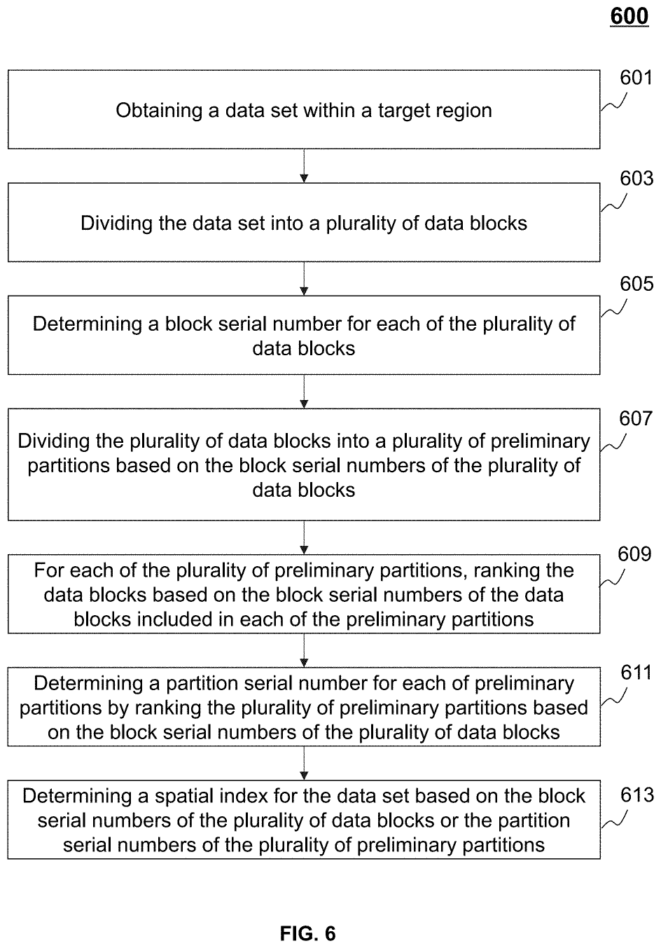

The data set processing module 403 may be configured to divide the data set into a plurality of preliminary partitions and determine a spatial index for the data set based on the plurality of preliminary partitions (e.g., as descried elsewhere in this disclosure in detail in connection with FIG. 6). In some embodiments, the preliminary partition may represent a geographic region in the target region. In some embodiments, the geographic region corresponding to the preliminary partition may have a regular (e.g. triangle, rectangle, square, circle, pentagon, hexagon) or irregular shape. In some embodiments, the spatial index may indicate a relationship between any two of the plurality of preliminary partitions. For example, for a target partition in the plurality of preliminary partitions, the spatial index may indicate which of the plurality of preliminary partitions is adjacent to the target partition.

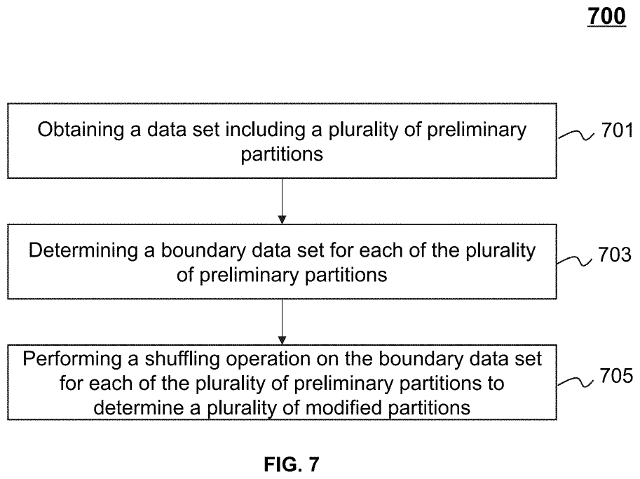

The extension module 405 may be configured to generate a plurality of modified partitions based on the plurality of preliminary partitions. In some embodiments, the extension module 405 may determine a boundary data set for each of the plurality of preliminary partitions and perform a shuffling operation on the boundary data set for each of the plurality of first preliminary partitions to determine the plurality of modified partitions (e.g., as descried elsewhere in this disclosure in detail in connection with FIG. 7).

The joining module 407 may be configured to join two data sets. In some embodiments, the joining module 407 may join at least one of a plurality of first modified partitions in a first data set and at least one of a plurality of second modified partitions in a second data set.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the data set processing module 403 may be integrated in the extension module 405 as a single module which may both determine a plurality of preliminary partitions and a plurality of modified partitions. As another example, the data set processing module 403 may be divided into two units. The first unit may be configured to determine a plurality of preliminary partitions. The second unit may be configured to determine a spatial index based on the plurality of preliminary partitions.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the processing engine 112 may further include a storage module (not shown in FIG. 4). The storage module may be configured to store data generated during any process performed by any component of in the processing engine 112. As another example, each of components of the processing engine 112 may include a storage apparatus. Additionally or alternatively, the components of the processing engine 112 may share a common storage apparatus.

Systems and methods in the present disclosure may be configured to join road network data sets with spatial big data sets including enormous (from a few billions to thousands of billion-scale) tracing points of user terminals communicated with an online on-demand service platform. To this end, the systems and methods provide an indexing system to support effectively management and processing of the data sets. According to embodiments of the present disclosure, the systems and methods may divide the special big data set into partitions and individually index each of the partitions. The systems and methods then may modify each of the partitions by adding thereto boundary data sets of regions surrounding the partitions and shuffle the boundary data sets. The systems and methods may do the same to the road network data set. When the online on-demand service platform needs to join a few partitions of the two data sets, such as when a user of the platform wants to know whether there is new road not included in an existing road network map, the above indexing systems of the two data sets may facilitate searching and joining of data from the two data sets in the corresponding partitions, especially when the data scale of the two data sets are of billion-scale and larger and the searching and joining operation is required to be completed in microseconds or nanoseconds.

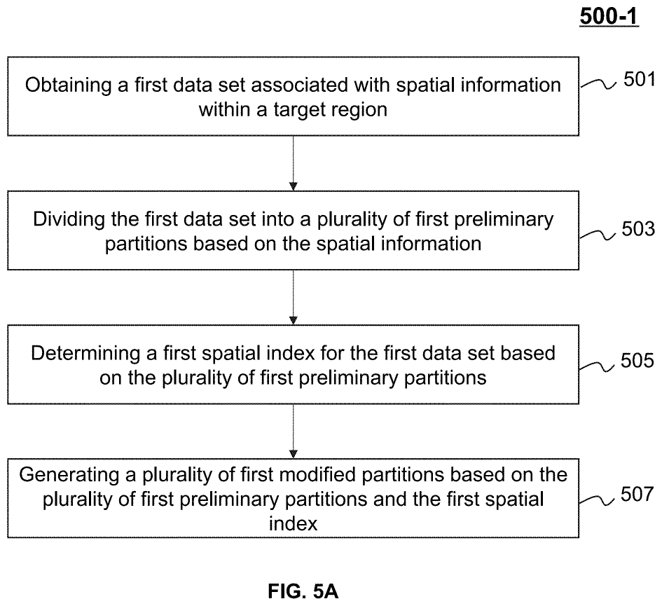

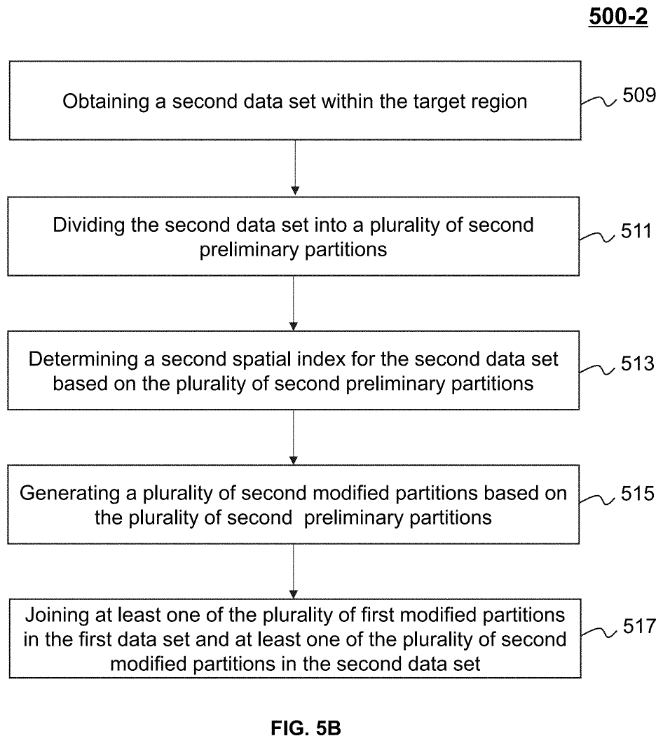

FIG. 5A is a flowchart illustrating an exemplary process for generating a plurality of first modified partitions according to some embodiments of the present disclosure. In some embodiments, the process 500-1 may be implemented in the on-demand service system 100 illustrated in FIG. 1. For example, the process 500-1 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 500-1 presented below are intended to be illustrative. In some embodiments, the process 500-1 may be accomplished with one or more additional operations not described, and/or without one or more of the operations discussed. Additionally, the order in which the operations of the process 500-1 as illustrated in FIG. 5A and described below is not intended to be limiting.

In 501, the obtaining module 401 (and/or the processing engine 112, and/or the interface circuits 210-a) may obtain a first data set associated with spatial information within a target region. In some embodiments, the processing engine 112 may obtain the first data set from the storage medium (e.g., the storage device 150, or the storage 220 in the computing device 200).

As used herein, the first data set may be a spatial big data set including a plurality of data points. Each data point may be a spatial coordinate or a representation of the location of a user terminal (e.g., a mobile device such as a smart phone) that is in communication with the online on-demand transportation platform 100. When a passenger or a driver holding the user terminal moves in a region, the platform 100 (or the server 110, the processor 220 etc.) may collect the location of the user terminal at certain frequency and record the location in the spatial big data set. Over time, the location of the user terminal may form a series of tracing points in the spatial big data set. Since there are millions of mobile devices in communication with the platform 100 every seconds, the number of the plurality of data points may be numerous. For example, the number of the plurality of data points may be in billion-scale (e.g., hundreds of billions). Commercially, when the platform 100 receives a request to search and/or process the spatial big data set, platform must return a result to the request in microseconds or nanoseconds. Therefore, the spatial big data set must be properly indexed to support the above processing requirement. The term “user” in the present disclosure may refer to an individual, an entity, or a tool that may request a service, order a service, provide a service, or facilitate the providing of the service. In the present disclosure, the terms “user” and “user terminal” may be used interchangeably.

Each of the plurality of data points may include spatial information. The spatial information of a data point included in the first data set may include a time point and a geographic location of a user corresponding to the data point at the time point. In some embodiments, the geographic location may be represented by coordinates of latitude and longitude, an address, or a point of interest (POI) name, or a combination thereof. In some embodiments, the plurality of data points may correspond to a certain time period and/or a target region. For example, the obtaining module 410 may obtain a plurality of data points corresponding to one day in Beijing.

In some embodiments, the user terminal 140 may establish a communication (e.g., a wireless communication) with the processing engine 112 and/or the storage device 150, via an application installed in the user terminal 140. The application may be associated with the on-demand service system 100. For example, the application may be a taxi-hailing application or a navigation application. The provider terminal 140 may obtain a location of a user through a positioning technology in the user terminal 140, for example, a GPS, a GLONASS, a COMPASS, a QZSS, a WiFi positioning technology, or the like, or any combination thereof. The application may direct the user terminal 140 to constantly or periodically send the real time or historical location of the user to the processing engine 112 and/or the storage device 150. Consequently, the processing engine 112 and/or the storage device 150 may receive the location of the user in real time or substantially real time. In addition, the processing engine 112 and/or the storage device 150 may also receive a historical location of the user corresponding to a specific time point or time period.

In some embodiments, each of the plurality of data points may further include a user identification (ID) of a user corresponding to the data point. The user may register an account of the application when the user first uses the application. The processing engine 112 may generate a user ID for the user after the user registration. The application may direct the user terminal 140 to send the user ID to the processing engine 112 and/or the storage device 150 along with the real time or historical location of the user.

In some embodiments, at least one of the plurality of data points may include information associated with a user corresponding to the at least one of the plurality of data points. The information associated with the user may include the name of the user, the age of the user, the phone number of the user, the gender of the user, the occupation of the user, a vehicle relating to the user, the plate number of the vehicle, the brand of the vehicle, the color of the vehicle, or the like, or any combination thereof. In some embodiments, such user information is included in all the data points or a portion of the data points. The user may input the information associated with the user through an interface of the application. The application may direct the user terminal 140 to send the information associated with the user to the processing engine 112 and/or the storage device 150 along with the real time or historical location of the user.

In some embodiments, when a user is in a process of requesting, using, or providing an on-demand service (e.g., a driver is providing a taxi-hailing service to a passenger), the application may direct the user terminal 140 associated with the user to send information associated with the on-demand service to the processing engine 112 and/or the storage device 150 along with the real time or historical location of the user. For example, when a user (e.g., a driver) is providing a taxi-hailing service to a passenger, the information associated with the taxi-hailing service being provided may include an origin of the trip, a destination of the trip, or the like, or any combination thereof.

In 503, the data set processing module 403 (and/or the processing engine 112, and/or the processing circuits 210-b) may divide the first data set into a plurality of first preliminary partitions based on the spatial information (e.g., as descried elsewhere in this disclosure in detail in connection with FIG. 6). In some embodiments, the first preliminary partition may represent a geographic region in the target region. In some embodiments, the geographic region corresponding to the first preliminary partition may have a regular (e.g. triangle, rectangle, square, circle, pentagon, hexagon) or irregular shape.

In 505, the data set processing module 403 (and/or the processing engine 112, and/or the processing circuits 210-b) may determine a first spatial index for the first data set based on the plurality of first preliminary partitions (e.g., as descried elsewhere in this disclosure in detail in connection with FIG. 6). The first spatial index may indicate a relationship between any two of the plurality of first preliminary partitions. For example, for a target partition in the plurality of first preliminary partitions, the first spatial index may indicate which of the plurality of first preliminary partitions is adjacent to the target partition.

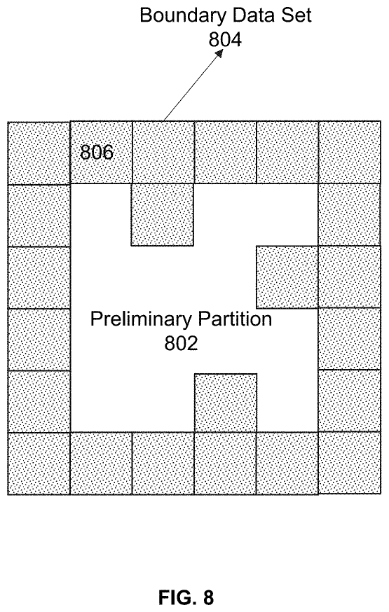

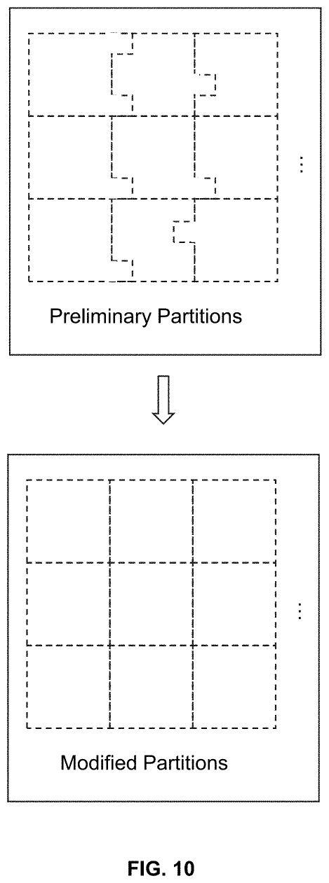

In 507, the extension module 405 (and/or the processing engine 112, and/or the processing circuits 210-b) may generate a plurality of first modified partitions based on the plurality of first preliminary partitions. In some embodiments, the extension module 405 may determine a boundary data set for each of the plurality of first preliminary partitions and perform a shuffling operation on the boundary data set for each of the plurality of first preliminary partitions to determine the plurality of first modified partitions (e.g., as descried elsewhere in this disclosure in detail in connection with FIG. 7). In some embodiments, a first preliminary partition may correspond to a first modified partition. For example, the first modified partition may be a modified first preliminary partition. In some embodiments, the plurality of first preliminary partitions may have irregular shapes (e.g., 802 shown in FIG. 8, preliminary partitions shown in FIG. 10), which may affect the integrity and/or the continuity of the data points in the plurality of first preliminary partitions. Therefore, the extension module 405 may modify the plurality of first preliminary partitions into regular shapes (e.g., modified partitions shown in FIG. 10) to improve the integrity and/or the continuity of the data points in the plurality of first preliminary partitions.

In some embodiments, the extension module 405 may determine the plurality of first modified partitions based on the plurality of first preliminary partitions according to a distributed computing method. The distributed computing method may include Storm framework, Spark framework, Hadoop, Phoenix, Disco, Mars, or the like, or any combination thereof. In some embodiments, the distributed computing method may be performed by a plurality of worker nodes and a manager that distributes tasks to the plurality of worker nodes. In some embodiments, the plurality of first preliminary partitions may be transmitted to the manager. The manager may distribute the plurality of first preliminary partitions to the plurality of worker nodes. For example, each of the plurality of first preliminary partitions may be transmitted to different worker nodes. As another example, one of the plurality of first preliminary partitions may be transmitted to a first worker node and another two of the plurality of first preliminary partitions may be transmitted to a second worker node. In some embodiments, the manager and/or the plurality of worker nodes may be a part of the processing engine 112 or communicate with the processing engine 112 via a network (e.g., the network 120).

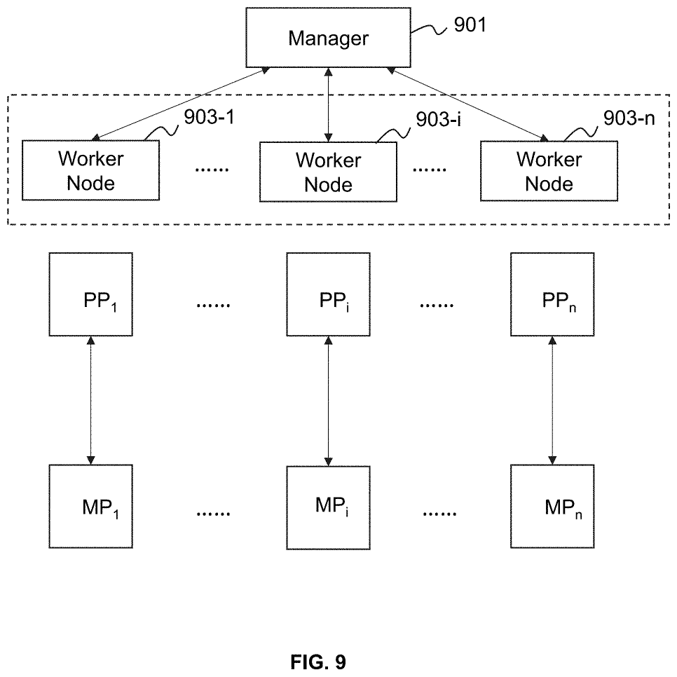

Merely by way of example, as shown in FIG. 9, the plurality of first preliminary partitions may be transmitted to a manager 901. The manager 901 may distribute the plurality of first preliminary partitions to a plurality of worker nodes (e.g., worker nodes 903-1, 903-i, 903-n, etc.). As shown in FIG. 9, each of the plurality of first preliminary partitions is transmitted to different worker nodes. For example, a preliminary partition PP₁ is transmitted to the worker node 903-1, a preliminary partition PP₁ is transmitted to the worker node 903-i, and a preliminary partition PPₙ is transmitted to the worker node 903-n. Each of the plurality of worker nodes may process its own preliminary partition and generate a modified partition. For example, the worker node 903-1 may process PP₁ and generate a modified partition MP₁ based on PP₁, the worker node 903-i may process PP₁ and generate a modified partition MP₁ based on PP₁, and the worker node 903-n may process PPₙ and generate a modified partition MPₙ based on PPₙ.

FIG. 5B is a flowchart illustrating an exemplary process for joining two data sets according to some embodiments of the present disclosure. In some embodiments, the process 500-2 may be implemented in the on-demand service system 100 illustrated in FIG. 1. For example, the process 500-2 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 500-2 presented below are intended to be illustrative. In some embodiments, the process 500-2 may be accomplished with one or more additional operations not described, and/or without one or more of the operations discussed. Additionally, the order in which the operations of the process 500-2 as illustrated in FIG. 5B and described below is not intended to be limiting. In some embodiments, the process 500-2 may be performed after the process 500-1.

In 509, the obtaining module 401 (and/or the processing engine 112, and/or the interface circuits 210-a) may obtain a second data set within the target region. In some embodiments, the obtaining module 401 may obtain the second data set from the storage medium (e.g., the storage device 150, or the storage 220 in the computing device 200).

In some embodiments, the second data set may be a road network map including road network information within the target region. In some embodiments, the road network information may include a plurality of transportation routes such as roads, streets, expressways, overpasses, rivers, subway routes, underpasses, or the like, or any combination thereof.

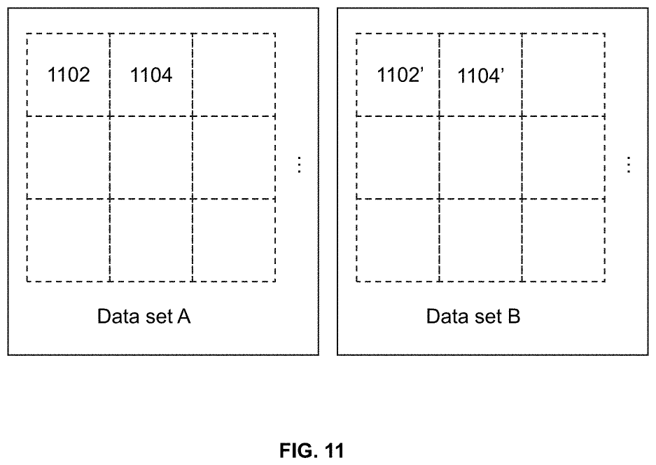

In some embodiments, the obtaining module 401 may obtain a second data set including a plurality of second modified partitions to join at least one of the plurality of first modified partitions in the first data set and at least one of the plurality of second modified partitions in the second data set. In some embodiments, for the plurality of second modified partitions, the location of the second modified partition, the area of the second modified partition, and the shape of the second modified partition may be different from the plurality of first modified partitions. Alternatively, for some or each of the plurality of second modified partitions, the location of the second modified partition, the area of the second modified partition, and the shape of the second modified partition may be the same as corresponding partitions of the plurality of first modified partitions, which indicates that the second modified partition corresponds to the first modified partition. For example, as shown in FIG. 11, a modified partition 1102 in data set A (e.g., the spatial bid data set and/or the user terminal tracing point data set) may correspond to a modified partition 1102′ in data set B (e.g., the road network map). The location, the area, and the shape of the modified partition 1102 are the same as the location, the area, and the shape of the modified partition 1102′. A modified partition 1104 in data set A corresponds to a modified partition 1104′ in data set B. The location, the area, and the shape of the modified partition 1104 are the same as the location, the area, and the shape of the modified partition 1104′. In some embodiments, data included in two corresponding modified partitions and/or the amounts of data of the two corresponding modified partitions may be different. For example, a first modified partition may include data points indicating locations of users, and a second modified partition corresponding to the first modified partition may include road network information.

In some embodiments, the process for generating the plurality of second modified partitions may be the same as the process for generating the plurality of first modified partitions illustrated in 503-507 of the process 500-1. Merely by way of example, the process for generating the plurality of second modified partitions may include 511-515.

In 511, the data set processing module 403 (and/or the processing engine 112, and/or the processing circuits 210-b) may divide the second data set into a plurality of second preliminary partitions (e.g., as descried elsewhere in this disclosure in detail in connection with FIG. 6). The second preliminary partition may represent a geographic region in the target region. In some embodiments, for each of the plurality of second preliminary partitions, the location of the second preliminary partition, the area of the second preliminary partition, and the shape of the second preliminary partition may be the same as one of the plurality of first preliminary partitions, which indicates that the second preliminary partition corresponds to the first preliminary partition. In some embodiments, data included in two corresponding preliminary partitions and/or the amounts of data of the two corresponding preliminary partitions may be different. For example, a first preliminary partition may include data points indicating locations of users, and a second preliminary partition corresponding to the first modified partition may include road network information. In some embodiments, in order to make the plurality of first preliminary partitions and the plurality of second preliminary partitions have a one-to-one correspondence relationship, the data set processing module 403 may divide the second data set into the plurality of second preliminary partitions based on the plurality of first preliminary partitions.

In 513, the data set processing module 403 (and/or the processing engine 112, and/or the processing circuits 210-b) may determine a second spatial index for the second data set based on the plurality of second preliminary partitions (e.g., as descried elsewhere in this disclosure in detail in connection with FIG. 6). The second spatial index may indicate a relationship between any two of the plurality of second preliminary partitions. For example, for a target partition in the plurality of second preliminary partitions, the second spatial index may indicate which of the plurality of second preliminary partitions is adjacent to the target partition.

In 515, the extension module 405 (and/or the processing engine 112, and/or the processing circuits 210-b) may generate a plurality of second modified partitions based on the plurality of second preliminary partitions. In some embodiments, the extension module 405 may determine a boundary data set for each of the plurality of second preliminary partitions and perform a shuffling operation on the boundary data set for each of the plurality of second preliminary partitions to determine the plurality of second modified partitions (e.g., as descried elsewhere in this disclosure in detail in connection with FIG. 7). In some embodiments, a second preliminary partition may correspond to a second modified partition. In some embodiments, the process for generating the plurality of second modified partitions may be the same as the process for generate the plurality of first modified partitions. In some embodiments, the extension module 405 may generate the plurality of second modified partitions in a distribution method the same as the distribution method described in 507.

In 517, the joining module 307 (and/or the processing engine 112, and/or the processing circuits 210-b) may join at least one of the plurality of first modified partitions and at least one of the plurality of second modified partitions. In some embodiments, a first modified partition may be joined with a second modified partitions that corresponds to the first modified partitions. For example, as shown in FIG. 11, the modified partition 1102 may be joined with the modified partition 1102′ corresponding to the modified partition 1102, and the modified partition 1104 may be joined with the modified partition 1104′ corresponding to the modified partition 1104.

In some embodiments, for a first modified partition (or second modified partition), the joining module 407 may search the second data set (or first data set) to determine a second modified partition (or first modified partition) corresponding to the first modified partition (or second modified partition) to perform a joining operation. In some embodiments, a partition serial number of the first modified partition in the first spatial index may relate to a partition serial number, in the second spatial index, of the second modified partition corresponding to the first modified partition. For example, the partition serial numbers of the first modified partition and the second modified partition may be MP₁, or the partition serial number of the first modified partition may be MP₁-A and the partition serial number of the second modified partition may be MP₁-B. The joining module 407 may search the second data set to determine the second modified partition corresponding to the first modified partition based on “MP₁”. In some embodiments, the joining module 407 may search the second data set to determine the second modified partition corresponding to the first modified partition based on the location, the area, and the shape of the first modified partition.

In an application scenario of finding one or more new transportation routes not included in a road network map, the joining module 407 may join the first data set (e.g., a plurality of data point) and the second data set (e.g., a road network map) to compare the first data set with the second data set to find one or more new transportation routes not included in the second data set (e.g., a road network map). For example, the joining of the first data set and the second data set may be just like covering a road network map with a transparent mask including a plurality of points (e.g., data points in the first data set). If a certain number of points (e.g., more than 1000 points) correspond to a region including no transportation route in the road network map, there may be one or more new transportation routes not included in the road network map.

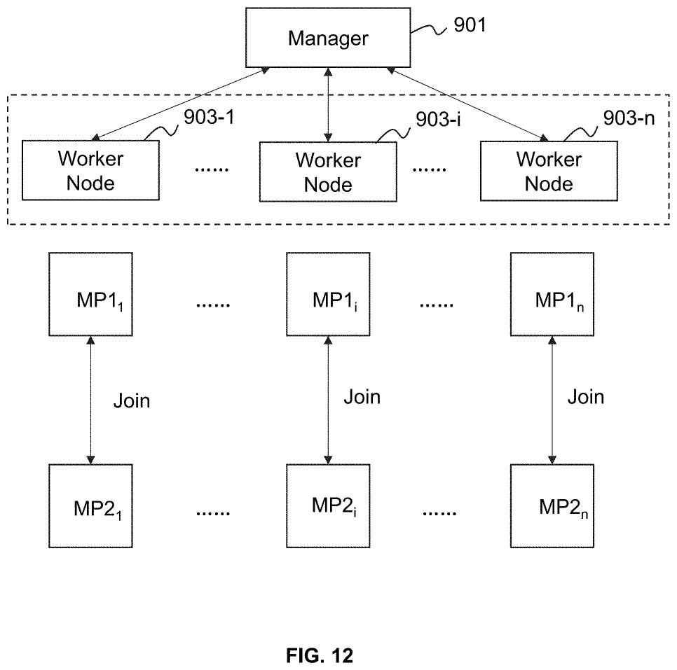

In some embodiments, the joining module 407 may join at least one of the plurality of first modified partitions and at least one of the plurality of second modified partitions according to a distributed computing method. Merely by way of example, as shown in FIG. 12, at least one of the plurality of first preliminary partitions (e.g., MP1₁, MP1ᵢ, MP1ₙ) and at least one of the plurality of second preliminary partitions (e.g., MP2₁, MP2ᵢ, MP2ₙ) may be transmitted to the manager 901. The manager 901 may distribute MP1₁ and MP2₁ corresponding to MP1₁ to the worker nodes 903-1. The manager 901 may distribute MP1ᵢ and MP2ᵢ corresponding to MP1ᵢ to the worker nodes 903-i. The manager 901 may distribute MP1ₙ and MP2ₙ corresponding to MP1ₙ to the worker nodes 903-n. The worker nodes 903-1 may join MP1₁ and MP2₁. The worker nodes 903-i may join MP1ᵢ and MP2ᵢ. The worker nodes 903-n may join MP1ₙ and MP2ₙ.

FIG. 6 is a flowchart illustrating an exemplary process for dividing a data set into a plurality of partitions according to some embodiments of the present disclosure (descriptions regarding the process for dividing a data set into a plurality of partitions may also be found in, for example, International Application No. PCT/CN2017/119699 filed on Dec. 29, 2017, which is hereby incorporated by reference). In some embodiments, the process 600 may be implemented in the on-demand service system 100 illustrated in FIG. 1. For example, the process 600 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 600 presented below are intended to be illustrative. In some embodiments, the process 600 may be accomplished with one or more additional operations not described, and/or without one or more of the operations discussed. Additionally, the order in which the operations of the process 600 as illustrated in FIG. 6 and described below is not intended to be limiting. In some embodiments, 503 and 505 of the process 500-1 illustrated in FIG. 5A, and/or 511 and 513 of the process 500-2 illustrated in FIG. 5B may be performed according to the process 600.

In 601, the obtaining module 401 (and/or the processing engine 112, and/or the interface circuits 210-a) may obtain a data set (e.g., the first data set, the second data set) within a target region. In some embodiments, the obtaining module 401 may obtain the data set from the storage medium (e.g., the storage device 150, or the storage 220 in the computing device 200).

In 603, the data set processing module 403 (and/or the processing engine 112, and/or the processing circuits 210-b) may divide the data set into a plurality of data blocks. In some embodiments, a data block may represent a geographic region. In some embodiments, each of the geographic regions may have a regular (e.g. triangle, rectangle, square, circle, pentagon, hexagon, etc.) or irregular shape. In some embodiments, the sizes of geographic regions may be same. For example, each of the geographic region may be a square of which the side length is 500 meters. In some embodiments, the sizes of geographic regions may be different. For example, the geographic region A may be a square of which the side length is 200 meters, and the geographic region B is a square of which the side length is 300 meters.

In some embodiments, for the first data set including a plurality of data points with spatial information, the data set processing module 403 may first divide the target region that the first data set corresponds to into the plurality of first data blocks, and then determine how many data points and/or which data points are in each first data block based on the spatial information of the plurality of data points. In some embodiments, for the second data set including road network information, the data set processing module 403 may divide the target region that the road network information corresponds to into the plurality of second data blocks. For each of the plurality of second data blocks, the location, the area, and the shape of the second data block may be the same as one of the plurality of first data blocks, which indicates that the second data block corresponds to the first data block. In some embodiments, data included in two corresponding data blocks and/or the amounts of data of the two corresponding data blocks may be different. For example, a first data block may include data points indicating locations of users, and a second data block corresponding to the first data block may include road network information.

In 605, the data set processing module 403 (and/or the processing engine 112, and/or the processing circuits 210-b) may determine a block serial number for each of the plurality of data blocks. In some embodiments, the data set processing module 403 may determine the block serial numbers based on a space-filling curve, for example, a Hilbert curve, a Z-order curve, a Quad tree, R-trees, a Hilbert R-tree, a Binary Space Partitioning (BSP) tree, a Gray curve, a Dragon curve, a Gosper curve, a Peano curve, or the like, or any combination thereof. In some embodiments, the space-filling curve is a Hilbert curve that, when used a map, passes through the geographic regions corresponding to the data blocks, leaving no empty space and no overlap. The data set processing module 403 may number the plurality of data blocks according to the order that the space-filling curve passes through geographic regions corresponding to the plurality of data blocks.

In some embodiments, the block serial numbers of two corresponding data blocks may relate to each other. For example, the block serial numbers of two corresponding data blocks may be same. As another example, a part of the block serial numbers of two corresponding data blocks may be same, such as B₁-A and B₁-B.

In 607, the data set processing module 403 (and/or the processing engine 112, and/or the processing circuits 210-b) may divide the plurality of data blocks into a plurality of preliminary partitions.

In some embodiments, for the first data set including a plurality of data points with the spatial information, the data set processing module 403 may divide the plurality of data blocks into the plurality of preliminary partitions based on an estimated distribution of data points of the plurality of data blocks and the block serial numbers of the plurality of data blocks.

As used herein, the estimated distribution of data points of the plurality of data blocks may indicate which data blocks include relatively more data points and which data blocks include relatively fewer data points. The estimated distribution may include an estimated density distribution of the plurality of data points, an estimated number distribution of the plurality of data points, or the like, or any combination thereof.

For example, for the estimated density distribution, the data set processing module 403 may determine, for each data block, a density of data points based on the number of data points in the data block and the size of the geographic region corresponding to the data block, and determine the estimated density distribution based on the density of data points in each data block. As another example, for the estimated number distribution, the data set processing module 403 may determine the number of data points in each data block, and determine the estimated number distribution based on the number of data points in each data block. Alternatively, the data set processing module 403 may select one or more data blocks from the plurality of data blocks as a sample, and determine the estimated distribution based on the density of data points and/or the number of data points in each of the selected one or more data blocks.

In order to improve the efficiency of data point processing, the number of data points in each preliminary partition may be substantially similar (e.g., differences between the numbers of data points in any two partitions are less than a threshold such as 100, 500, 1000, 5000, or 10000 data points). In some embodiments, the data set processing module 403 may divide the plurality of data blocks into the plurality of preliminary partitions based on the estimated distribution of the plurality of data points to make the number of data points in each preliminary partition substantially similar. In some embodiments, the block serial numbers of data blocks in a preliminary partition may be continuous. For example, the block serial numbers of data blocks in a preliminary partition may be 1-10000.

In some embodiments, the numbers of data blocks of two corresponding preliminary partitions may be equal. The data blocks in the two corresponding preliminary partitions may have a one-to-one correspondence relationship.

In 609, for each of the plurality of preliminary partitions, the data set processing module 403 (and/or the processing engine 112, and/or the processing circuits 210-b) may rank the data blocks based on the block serial numbers of the data blocks included in each of the preliminary partitions.

For example, a preliminary partition may include 1000 data blocks of which the block serial numbers are 10001-11000. In some embodiments, the data set processing module 403 may rank the 1000 data blocks in the ascending order and determine the data block with the block serial number of 10001 as the first data block in the preliminary partition. Alternatively, in some embodiments, the data set processing module 403 may rank the 1000 data blocks in the descending order and determine the data block with the block serial number of 11000 as the first data block in the preliminary partition.

In 611, the data set processing module 403 (and/or the processing engine 112, and/or the processing circuits 210-b) may determine a partition serial number for each of preliminary partitions by ranking the plurality of preliminary partitions based on the block serial numbers of the plurality of data blocks. For example, the data set processing module 403 may determine a partition serial number of PP₁ for a preliminary partition that includes data blocks of which the block serial numbers are 1-10000, and determine a partition serial number of PP₂ for a preliminary partition includes data blocks of which the block serial numbers are 10001-11000.

In some embodiments, the partition serial numbers of two corresponding partitions may relate to each other. For example, the partition serial numbers of two corresponding partitions may be same. As another example, a part of the partition serial numbers of two corresponding partitions may be same, such as PP₁-A and PP₁-B.

In 613, the data set processing module 403 (and/or the processing engine 112, and/or the processing circuits 210-b) may determine a spatial index for the data set based on the block serial numbers of the plurality of data blocks and the partition serial numbers of the plurality of preliminary partitions. The spatial index may indicate a relationship of the plurality of data blocks and the plurality of preliminary partitions. For example, for a data block, the spatial index may indicate which preliminary partition includes the data block and which data block is adjacent to the data block. As another example, for a preliminary partition, the spatial index may indicate which data blocks are included in the preliminary partition and which preliminary partition is adjacent to the preliminary partition.

It should be noted that the above description for distributing the plurality of service requests is merely provided for the purpose of illustration, and not intend to limit the scope of the present disclosure. For persons having ordinary skills in the art, multiple variations and modifications may be made under the teachings of the present disclosure. However, those variations and modifications do not depart from the present disclosure. For example, step 609 may be omitted in some embodiments.

FIG. 7 is a flowchart illustrating an exemplary process for generating a plurality of modified partitions according to some embodiments of the present disclosure. In some embodiments, the process 700 may be implemented in the on-demand service system 100 illustrated in FIG. 1. For example, the process 700 may be stored in a storage medium (e.g., the storage device 150, or the storage 220 of the processing engine 112) as a form of instructions, and invoked and/or executed by the server 110 (e.g., the processing engine 112 of the server 110, the processor 220 of the processing engine 112, or one or more modules in the processing engine 112 illustrated in FIG. 4). The operations of the illustrated process 700 presented below are intended to be illustrative. In some embodiments, the process 700 may be accomplished with one or more additional operations not described, and/or without one or more of the operations discussed. Additionally, the order in which the operations of the process 700 as illustrated in FIG. 7 and described below is not intended to be limiting. In some embodiments, step 507 of the process 500-1 illustrated in FIG. 5A and/or step 515 of the process 500-2 illustrated in FIG. 5B may be performed according to the process 700.

In 701, the obtaining module 401 (and/or the processing engine 112, and/or the interface circuits 210-a) may obtain a data set (e.g., the first data set or the second data set) including a plurality of preliminary partitions (e.g., first preliminary partitions, second preliminary partitions). In some embodiments, the data set may be divided into the preliminary partitions based on the process 600 illustrated in FIG. 6.

In 703, the extension module 405 (and/or the processing engine 112, and/or the processing circuits 210-b) may determine a boundary data set for each of the plurality of preliminary partitions. In some embodiments, the boundary data set for a preliminary partition may be adjacent to and surround the preliminary partition. In some embodiments, a boundary data set for a preliminary partition may include a plurality of data blocks determined in 603 of the process 600 illustrated in FIG. 6. For example, as shown in FIG. 8, a data set is divided into a plurality of data blocks (e.g., 806). For a preliminary partition 802, the extension module 405 may determine a boundary data set 804 including data blocks (e.g., grey squares like 806 in FIG. 8) that are adjacent to and surround the preliminary partition 802.

In some embodiments, the data set processing module 403 may determine the boundary data set for a preliminary partition based on a spatial index of the data set. In some embodiments, the data set processing module 403 may determine which data blocks are included in the preliminary partition based on the spatial index. The block serial numbers of the data blocks included in the preliminary partition may be referred to as a spatial index range of the preliminary partition. For example, a preliminary partition may be represented as PP₁[1-10000], which indicates that the partition serial number of the preliminary partition is PP₁, and data blocks of which the block serial numbers are 1-10000 are included in the preliminary partition. The range of 1-10000 may be the spatial index range of the preliminary partition. In some embodiments, the extension module 405 may determine the boundary data set of the preliminary partition by determining the block serial numbers of data blocks that are adjacent to and surround the preliminary partition, and which preliminary partitions include the data blocks that are adjacent to and surround the preliminary partition based on the spatial index range of the preliminary partition and the spatial index of the data set.

In 705, the extension module 405 (and/or the processing engine 112, and/or the processing circuits 210-b) may perform a shuffling operation on the boundary data set for each of the plurality of preliminary partitions. In some embodiments, the shuffling operation may refer to data exchange among two or more preliminary partitions. In some embodiments, the shuffling operation on a boundary data set of a preliminary partition may include ranking the data blocks included in the boundary data set based on the block serial numbers of the data blocks and adding the boundary data set including the ranked data blocks to the preliminary partition. The combination of the preliminary partition and the boundary data set may be referred to as a modified partition. For example, the extension module 405 may determine a boundary data set of [10001-10400] for a preliminary partition of [1-10000]. A set of [1-10400] may be a modified partition.

In some embodiments, because a modified partition corresponding to a preliminary partition may be generate by shuffling a boundary data set of the preliminary partition instead of the preliminary partition or the whole data set, the order of magnitude of the calculated amount of generating the modified partition may be the square root of the order of magnitude of the amount of data in the preliminary partition, which improves the efficiency of generating a modified partition compared to generating a modified partition by processing all data in the data set in existing technology.

FIG. 8 is a schematic diagram illustrating an exemplary boundary data set according to some embodiments of the present disclosure. As shown in FIG. 8, a boundary data set 804 of a preliminary partition 802 includes a plurality of data blocks (e.g., grey squares like 806). The boundary data set 804 may be adjacent to and surround the preliminary partition 802.

FIG. 9 is a schematic diagram illustrating an exemplary process for determining a plurality of modified partitions based on a plurality of preliminary partitions based on a distributed computing method according to some embodiments of the present disclosure. In some embodiments, the extension module 405 may determine a plurality of first (or second) modified partitions based on a plurality of first (or second) preliminary partitions according to a distributed computing method. The distributed computing method may include Storm framework, Spark framework, Hadoop, Phoenix, Disco, Mars, or the like, or any combination thereof. In some embodiments, the distributed computing method may be performed by a plurality of worker nodes and a manager that distributes tasks to the plurality of worker nodes. Taking the determination of the plurality of first modified partitions as an example, the plurality of first preliminary partitions may be transmitted to the manager. The manager may distribute the plurality of first preliminary partitions to the plurality of worker nodes. For example, each of the plurality of first preliminary partitions may be transmitted to different worker nodes. As another example, one of the plurality of first preliminary partitions may be transmitted to a first worker node and another two of the plurality of first preliminary partitions may be transmitted to a second worker node. In some embodiments, the manager and/or the plurality of worker nodes may be a part of the processing engine 112 or communicate with the processing engine via a network (e.g., the network 120).

Merely by way of example, as shown in FIG. 9, the plurality of first preliminary partitions (e.g., PP₁, PPᵢ, PPₙ) may be transmitted to the manager 901. The manager 901 may distribute the plurality of first preliminary partitions to the plurality of worker nodes (e.g., worker nodes 903-1, 903-i, 903-n, etc.). As shown in FIG. 9, each of the plurality of first preliminary partitions is transmitted to different worker node. For example, PP₁ is transmitted to the worker node 903-1, PPᵢ is transmitted to the worker node 903-i, and PPₙ is transmitted to the worker node 903-n. Each of the plurality of worker nodes may process its own preliminary partition and generate a modified partition. For example, the worker node 903-1 may process PP₁ and generate a modified partition MP₁ based on PP₁, the worker node 903-i may process PPᵢ and generate a modified partition MPᵢ based on PPᵢ, and the worker node 903-n may process PPₙ and generate a modified partition MPₙ based on PPₙ.

FIG. 10 is a schematic diagram illustrating exemplary modified partitions and exemplary preliminary partitions according to some embodiments of the present disclosure. As shown in FIG. 10, the shapes of the preliminary partitions are irregular. The shapes of the modified partitions generated by processing the preliminary partitions based on the process 500-1, the process 600, and/or the process 700 are regular, which improves the integrity and the continuity of the preliminary partitions.

FIG. 11 is a schematic diagram illustrating exemplary corresponding modified partitions according to some embodiments of the present disclosure. As shown in FIG. 11, a modified partition 1102 in data set A corresponds to a modified partition 1102′ in data set B. The location, the area, and the shape of the modified partition 1102 are the same as the location, the area, and the shape of the modified partition 1102′. A modified partition 1104 in data set A corresponds to a modified partition 1104′ in data set B. The location, the area, and the shape of the modified partition 1104 are the same as the location, the area, and the shape of the modified partition 1104′.

FIG. 12 is a schematic diagram illustrating an exemplary process for joining two data sets based on a distributed computing method according to some embodiments of the present disclosure. In some embodiments, the joining module 407 may join a first data set and a second data set according to a distributed computing method. The distributed computing method may include Storm framework, Spark framework, Hadoop, Phoenix, Disco, Mars, or the like, or any combination thereof. In some embodiments, the distributed computing method may be performed by a plurality of worker nodes and a manager that distributes tasks to the plurality of worker nodes. At least one of the plurality of first preliminary partitions (e.g., MP1₁, MP1ᵢ, MP1ₙ) and at least one of the plurality of second preliminary partitions (e.g., MP2₁, MP2ᵢ, MP2ₙ) may be transmitted to the manager 901. The manager 901 may distribute MP1₁ and MP2₁ corresponding to MP1₁ to the worker nodes 903-1. The manager 901 may distribute MP1ᵢ and MP2ᵢ corresponding to MP1ᵢ to the worker nodes 903-i. The manager 901 may distribute MP1ₙ and MP2ₙ corresponding to MP1ₙ to the worker nodes 903-n. The worker nodes 903-1 may join MP1₁ and MP2₁. The worker nodes 903-i may join MP1ᵢ and MP2ᵢ. The worker nodes 903-n may join MP1ₙ and MP2ₙ.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. A data processing electronic system to optimize Spatial Big Data partitions, comprising:
at least one storage medium including a set of instructions for partitioning Spatial Big Data sets;
at least one processor in communication with the at least one storage medium, wherein when executing the set of instructions, the at least one processor is directed to:
obtain a first data set, the first data set being a Spatial Big Data set associated with spatial information within a target region;
divide the first data set into a plurality of first preliminary partitions based on the spatial information;
determine a first spatial index for the first data set based on the plurality of first preliminary partitions; and
generate a plurality of first modified partitions by
obtaining a plurality of first boundary data sets associated with the plurality of first preliminary partitions based on the first spatial index, wherein the plurality of first boundary data sets includes data associated with one or more first regions surrounding the plurality of first preliminary partitions; and
conducting a first shuffling operation to the plurality of first boundary data sets.

2. The system of claim 1, wherein the obtaining of the plurality of first boundary data sets associated with the plurality of first preliminary partitions includes:
determining a spatial index range for each of the plurality of first preliminary partitions based on the first spatial index; and
determining the plurality of first boundary data sets associated with the plurality of first preliminary partitions based on the spatial index ranges of the plurality of first preliminary partitions.

3. The system of claim 1, the at least one processor is further directed to:
conduct distribute computation to the plurality of first preliminary partitions to generate the plurality of first modified partitions according to a distributed computing method.

4. The system of claim 3, the at least one processor is further directed to:
obtain a second data set within the target region;
divide the second data set into a plurality of second preliminary partitions;
determine a second spatial index for the second data set based on the plurality of second preliminary partitions; and
conduct distributed computation to the plurality of second preliminary partitions to generate a plurality of second modified partitions according to the distributed computing method and the second spatial index.

5. The system of claim 4, wherein to generate the plurality of second modified partitions, the at least one processor is further directed to:
obtain a plurality of second boundary data sets associated with the plurality of second preliminary partitions based on the second spatial index, wherein the plurality of second boundary data sets includes data associated with one or more second regions surrounding the plurality of second preliminary partitions; and
conduct a second shuffling operation to the plurality of second boundary data sets to generate the plurality of second modified partitions.

6. The system of claim 4, the at least one processor is further directed to:
join at least one of the plurality of first modified partitions in the first data set and at least one of the plurality of second modified partitions in the second data set.

7. The system of claim 4, wherein the first data set includes tracing points of a plurality of user terminals communicated with the electronic system, and the second data set includes road network information of the target region.

8. The system of claim 4, wherein for each of the plurality of second modified partitions, a location of the second modified partition, an area of the second modified partition, and a shape of the second modified partition are same as one of the plurality of first modified partitions.

9. The system of claim 4, wherein the first spatial index or the second spatial index is associated with at least one of a Hilbert curve or a Z-curve.

10. The system of claim 3, wherein the distributed computing method includes at least one of Spark framework, Hadoop, Phoenix, Disco, or Mars.

11. A method to optimize Spatial Big Data partitions implemented on a computing device having at least one processor and at least one storage medium, the method comprising:
obtaining, by the at least one processor, a first data set, the first data set being a Spatial Big Data set associated with spatial information within a target region;
dividing, by the at least one processor, the first data set into a plurality of first preliminary partitions based on the spatial information;
determining, by the at least one processor, a first spatial index for the first data set based on the plurality of first preliminary partitions; and
generating, by the at least one processor, a plurality of first modified partitions by
obtaining a plurality of first boundary data sets associated with the plurality of first preliminary partitions based on the first spatial index, wherein the plurality of first boundary data sets includes data associated with one or more first regions surrounding the plurality of first preliminary partitions; and
conducting a first shuffling operation to the plurality of first boundary data sets.

12. The method of claim 11, wherein the obtaining of the plurality of first boundary data sets associated with the plurality of first preliminary partitions includes:
determining a spatial index range for each of the plurality of first preliminary partitions based on the first spatial index; and
determining the plurality of first boundary data sets associated with the plurality of first preliminary partitions based on the spatial index ranges of the plurality of first preliminary partitions.

13. The method of claim 11, the method further comprising:
conducting, by the at least one processor, distribute computation to the plurality of first preliminary partitions to generate the plurality of first modified partitions according to a distributed computing method.

14. The method of claim 13, the method further comprising:
obtaining, by the at least one processor, a second data set within the target region;
dividing, by the at least one processor, the second data set into a plurality of second preliminary partitions;
determining, by the at least one processor, a second spatial index for the second data set based on the plurality of second preliminary partitions; and
conducting, by the at least one processor, distributed computation to the plurality of second preliminary partitions to generate a plurality of second modified partitions according to the distributed computing method and the second spatial index.

15. The method of claim 14, wherein the generating of the plurality of second modified partitions includes:
obtaining, by the at least one processor, a plurality of second boundary data sets associated with the plurality of second preliminary partitions based on the second spatial index, wherein the plurality of second boundary data sets includes data associated with one or more second regions surrounding the plurality of second preliminary partitions; and
conducting, by the at least one processor, a second shuffling operation to the plurality of second boundary data sets to generate the plurality of second modified partitions.

16. The method of claim 14, the method further comprising:
joining, by the at least one processor, at least one of the plurality of first modified partitions in the first data set and at least one of the plurality of second modified partitions in the second data set.

17. The method of claim 14, wherein the first data set includes tracing points of a plurality of user terminals communicated with the electronic system, and the second data set includes road network information of the target region.

18. The method of claim 14, wherein for each of the plurality of second modified partitions, a location of the second modified partition, an area of the second modified partition, and a shape of the second modified partition are same as one of the plurality of first modified partitions.

19. The method of claim 14, wherein the first spatial index or the second spatial index is associated with at least one of a Hilbert curve or a Z-curve; or
wherein the distributed computing method includes at least one of Spark framework, Hadoop, Phoenix, Disco, or Mars.

20-30. (canceled)

31. A non-transitory computer readable medium, comprising at least one set of instructions for indexing data, wherein when executed by one or more processors of a computing device, the at least one set of instructions causes the computing device to perform a method, the method comprising:
obtaining, by the at least one processor, a first data set, the first data set being a Spatial Big Data set associated with spatial information within a target region;
dividing, by the at least one processor, the first data set into a plurality of first preliminary partitions based on the spatial information;
determining, by the at least one processor, a first spatial index for the first data set based on the plurality of first preliminary partitions; and
generating, by the at least one processor, a plurality of first modified partitions by
obtaining a plurality of first boundary data sets associated with the plurality of first preliminary partitions based on the first spatial index, wherein the plurality of first boundary data sets includes data associated with one or more first regions surrounding the plurality of first preliminary partitions; and
conducting a first shuffling operation to the plurality of first boundary data sets.
